(19) United States
(12) Patent Application Publication
(10) Pub. No.: US 2026/0105473 A1
(43) Pub. Date: Apr. 16, 2026

(54) OUTLIER CORRECTION DEVICE, OUTLIER CORRECTION METHOD, AND MEDIUM

(71) Applicant: NEC Corporation, Tokyo (JP)

(72) Inventors: Yudai YAMAGUCHI, Tokyo (JP); Izumi KUWATA, Tokyo (JP); You IWAKAMI, Tokyo (JP)

(73) Assignee: NEC Corporation, Tokyo (JP)

(21) Appl. No.: 19/347,983

(22) Filed: Oct. 2, 2025

(30) Foreign Application Priority Data
Oct. 15, 2024 (JP) 2024-179927

(51) Int. Cl. G06Q 30/0202

(52) U.S. Cl. CPC G06Q 30/0202

(57) ABSTRACT

An outlier correction device includes a memory configured to store instructions; and one or more processors configured to execute the instructions to: detect an outlier from an actual value of a distribution volume of a product for each unit period; accept designation of a starting point of a first period corresponding to the outlier detected by a user; calculating a correction value of an actual value in the first period based on an actual value in a second period before the starting point; propose the calculated correction value to the user; and present, to the user, a first option of not correcting the actual value in the first period, a second option of temporarily correcting the actual value in the first period with the correction value, and a third option of confirming correction of the actual value in the first period.

This application is based upon and claims the benefit of priority from Japanese Patent Application No. 2024-179927, filed on October 15, 2024, the disclosure of which is incorporated herein in its entirety by reference.

### TECHNICAL FIELD

The present disclosure relates to an outlier correction device, an outlier correction method, and a medium.

### BACKGROUND ART

A technology for performing demand prediction is known. For example, JP 2022-084757 A discloses a prediction system that acquires, as input information, a category of a product, number of products shipped from a wholesaler to a retailer one day to seven days before a target date, and number of inventory days or average number of products sold at the retailer, and inputs the input information to a learning model generated by executing supervised learning, thereby outputting, from the learning model, prediction information regarding the number of products shipped by the wholesaler to the retailer on the target date.

### SUMMARY

The present disclosure has been made in view of the above problems, and an example object thereof is to provide a technology for more accurately performing demand prediction of a product.

An outlier correction device according to an example aspect of the present disclosure includes an outlier detection means for detecting an outlier from an actual value of a distribution volume of a product for each unit period, an accepting means for accepting designation of a starting point of a first period corresponding to the outlier detected by the outlier detection means by a user, a correction proposal means for calculating a correction value of an actual value in the first period based on an actual value in a second period before the starting point accepted by the accepting means and proposing the calculated correction value to the user, and an option presentation means for presenting, to the user, a first option of not correcting the actual value in the first period, a second option of temporarily correcting the actual value in the first period with the correction value, and a third option of confirming correction of the actual value in the first period.

An outlier correction method according to an example aspect of the present disclosure includes outlier detection processing in which at least one processor detects an outlier from an actual value of a distribution volume of a product for each unit period, acceptance processing in which the at least one processor accepts designation of a starting point of a first period corresponding to the outlier detected in the outlier detection processing by a user, correction proposal processing in which the at least one processor calculates a correction value of an actual value in the first period based on an actual value in a second period before the starting point accepted in the acceptance processing and proposes the calculated correction value to the user, and option presentation processing in which the at least one processor presents, to the user, a first option of not correcting the actual value in the first period, a second option of temporarily correcting the actual value in the first period with the correction value, and a third option of confirming correction of the actual value in the first period.

An outlier correction program according to an example aspect of the present disclosure is an outlier correction program for causing a computer to function as an outlier correction device, the outlier correction program causing the computer to function as: an outlier detection means for detecting an outlier from an actual value of a distribution volume of a product for each unit period, an accepting means for accepting designation of a starting point of a first period corresponding to the outlier detected by the outlier detection means by a user, a correction proposal means for calculating a correction value of an actual value in the first period based on an actual value in a second period before the starting point accepted by the accepting means and proposing the calculated correction value to the user, and an option presentation means for presenting, to the user, a first option of not correcting the actual value in the first period, a second option of temporarily correcting the actual value in the first period with the correction value, and a third option of confirming correction of the actual value in the first period.

### BRIEF DESCRIPTION OF THE DRAWINGS

FIG. 1 is a block diagram illustrating a configuration of an outlier correction device according to the present disclosure;

FIG. 2 is a flowchart illustrating a flow of an outlier correction method according to the present disclosure;

FIG. 3 is a diagram illustrating a configuration of a demand prediction system according to the present disclosure;

FIG. 4 is a block diagram illustrating a configuration of an information processing device according to the present disclosure;

FIG. 5 is a flowchart illustrating a flow of an information processing method according to the present disclosure;

FIG. 6 is a diagram illustrating an example of a screen according to the present disclosure;

FIG. 7 is a diagram illustrating an example of a graph according to the present disclosure; and

FIG. 8 is a block diagram illustrating a configuration of a computer that functions as an outlier correction device and an information processing device according to the present disclosure.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining technologies (some or all of things or methods) adopted in the following example embodiments can also be included in the scope of the present disclosure. Example embodiments obtained by appropriately omitting some of the technologies adopted in the following example embodiments can also be included in the scope of the present disclosure. Effects mentioned in the following example embodiments are examples of effects expected in the example embodiments, and do not define extension of the present disclosure. In other words, example embodiments that do not provide the effects mentioned in the following example embodiments can also be included in the scope of the present disclosure.

### First Example Embodiment

A first example embodiment that is an example of the example embodiments of the present disclosure will be described in detail with reference to the drawings. The present example embodiment is a basic form of each example embodiment to be described below. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in the drawings referred to for describing the present example embodiment can also be adopted in another example embodiment included in the present disclosure within a range in which no particular technical problem occurs.

### Configuration of Outlier Correction Device

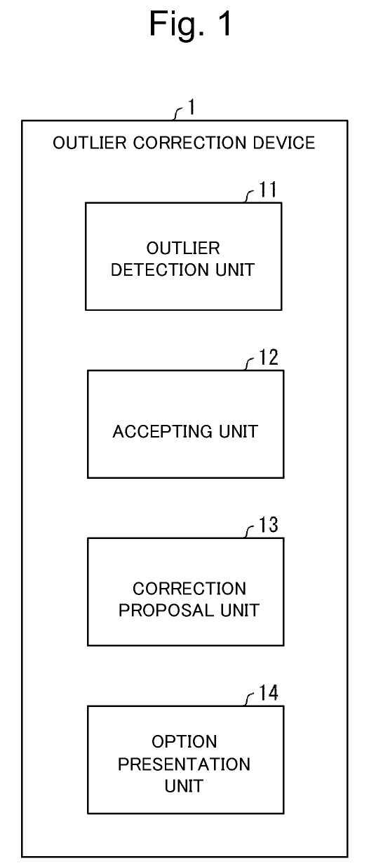

A configuration of an outlier correction device 1 will be described with reference to FIG. 1. FIG. 1 is a block diagram illustrating a configuration of the outlier correction device 1. As illustrated in FIG. 1, the outlier correction device 1 includes an outlier detection unit 11, an accepting unit 12, a correction proposal unit 13, and an option presentation unit 14.

The outlier detection unit 11 detects an outlier from an actual value of the distribution volume of the product for each unit period. The accepting unit 12 accepts designation of a starting point of a first period corresponding to the outlier detected by the outlier detection unit 11 by a user. The correction proposal unit 13 calculates a correction value of the actual value in the first period based on an actual value in a second period before the starting point accepted by the accepting unit 12, and proposes the calculated correction value to the user. The option presentation unit 14 presents, to the user, a first option of not correcting the actual value in the first period, a second option of temporarily correcting the actual value in the first period with the correction value, and a third option of confirming the correction of the actual value in the first period.

### Effects of Outlier Correction Device

As described above, the outlier correction device 1 adopts a configuration including the outlier detection unit 11 for detecting an outlier from an actual value of the distribution volume of the product for each unit period, the accepting unit 12 for accepting designation of a starting point of a first period corresponding to the outlier detected by the outlier detection unit 11 by the user, the correction proposal unit 13 for calculating a correction value of the actual value in the first period based on an actual value in a second period before the starting point accepted by the accepting unit 12 and proposing the calculated correction value to the user, and the option presentation unit 14 for presenting, to the user, a first option of not correcting the actual value in the first period, a second option of temporarily correcting the actual value in the first period with the correction value, and a third option of confirming the correction of the actual value in the first period. Therefore, according to the outlier correction device 1, an effect of presenting the user with options for more accurately performing the demand prediction of the product is obtained.

### Flow of Outlier Correction Method

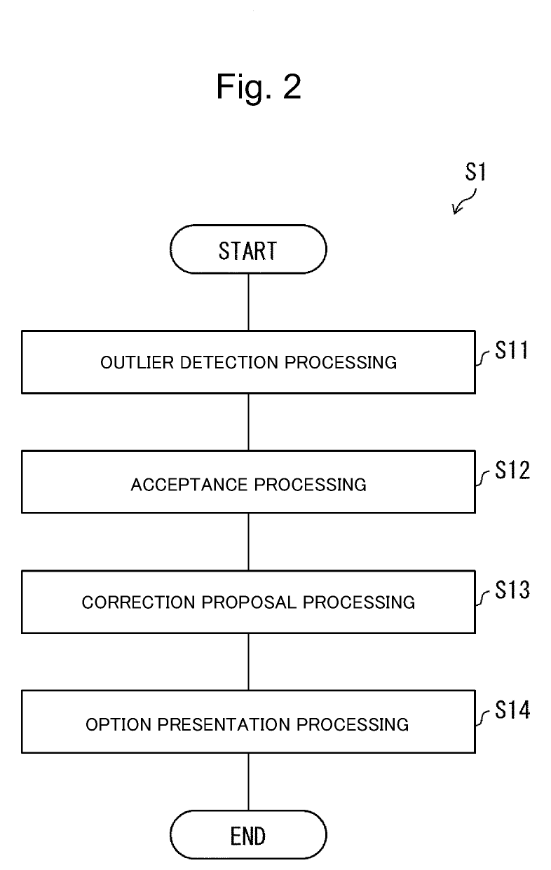

The flow of the outlier correction method S1 will be described with reference to FIG. 2. FIG. 2 is a flowchart illustrating a flow of the outlier correction method S1. As illustrated in FIG. 2, the outlier correction method S1 includes an outlier detection processing S11, an acceptance processing S12, a correction proposal processing S13, and an option presentation processing S14.

In the outlier detection processing S11, at least one processor detects an outlier from an actual value of the distribution volume of the product for each unit period. In the acceptance processing S12, the at least one processor accepts designation of a starting point of a first period corresponding to the outlier detected in the outlier detection processing S11 by the user. In the correction proposal processing S13, the at least one processor calculates a correction value of the actual value in the first period based on an actual value in a second period before the starting point accepted in the acceptance processing S12, and proposes the calculated correction value to the user. In the option presentation processing S14, the at least one processor presents, to the user, a first option in which the actual value in the first period is not corrected, a second option in which the actual value in the first period is temporarily corrected with the correction value, and a third option in which the correction of the actual value in the first period is confirmed.

### Effect of Outlier Correction Method

As described above, the outlier correction method S1 adopts a configuration including the outlier detection processing S11 in which at least one processor detects an outlier from an actual value of the distribution volume of the product for each unit period, the acceptance processing S12 in which the at least one processor accepts designation of a starting point of a first period corresponding to the outlier detected in the outlier detection processing S11 by the user, the correction proposal processing S13 in which the at least one processor calculates a correction value of the actual value in the first period based on an actual value in a second period before the starting point accepted in the acceptance processing S12, and presents the calculated correction value to the user, and the option presentation processing S14 in which the at least one processor presents, to the user, a first option in which the actual value in the first period is not corrected, a second option in which the actual value in the first period is temporarily corrected with the correction value, and a third option in which the correction of the actual value in the first period is confirmed. Therefore, according to the outlier correction method S1, an effect that the options for more accurately performing the demand prediction of the product can be presented to the user is obtained.

### Second Example Embodiment

A second example embodiment that is an example of the example embodiments of the present disclosure will be described in detail with reference to the drawings. Components that have the same functions as the components described in the above-described example embodiment are denoted by the same reference signs, and description of the components will be appropriately omitted. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in each of the drawings referred to for describing the present example embodiment can be employed in the other example embodiments included in the present disclosure within a range in which no particular technical problem occurs.

### Configuration of Demand Prediction System

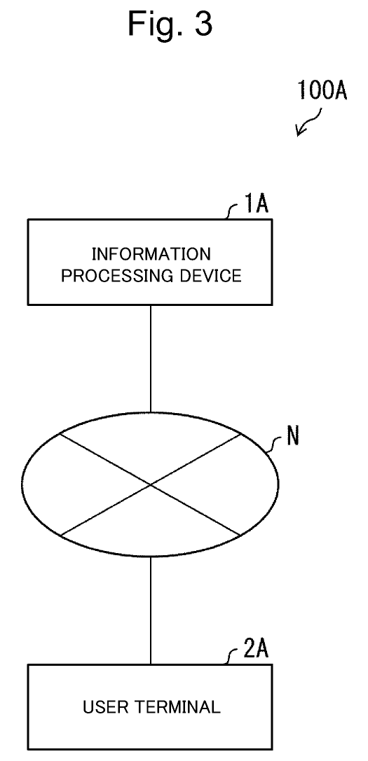

A configuration of a demand prediction system 100A according to the present disclosure will be described with reference to FIG. 3. FIG. 3 is a block diagram illustrating a configuration of the demand prediction system 100A. The demand prediction system 100A is a system that predicts a demand for a product, and includes an information processing device 1A and a user terminal 2A. The information processing device 1A and the user terminal 2A are communicably connected via a communication line N. Although a specific configuration of the communication line N is not limited to the present example embodiment, the communication line N is, by way of example, a wireless Local Area Network (LAN), a wired LAN, a Wide Area Network (WAN), a public line network, a mobile data communication network, or a combination thereof.

The information processing device 1A is a device having a function of predicting a demand for a product, and is, for example, a general-purpose server. The information processing device 1A may also be a personal computer such as a laptop personal computer or a tablet terminal. The user terminal 2A is a terminal used by a user (e.g., a planner of a manufacturer), and is, for example, a personal computer such as a laptop personal computer or a tablet terminal. Although one user terminal 2A is illustrated in the example of FIG. 3, two or more user terminals 2A may be included in the demand prediction system 100A.

### Configuration of Information Processing Device

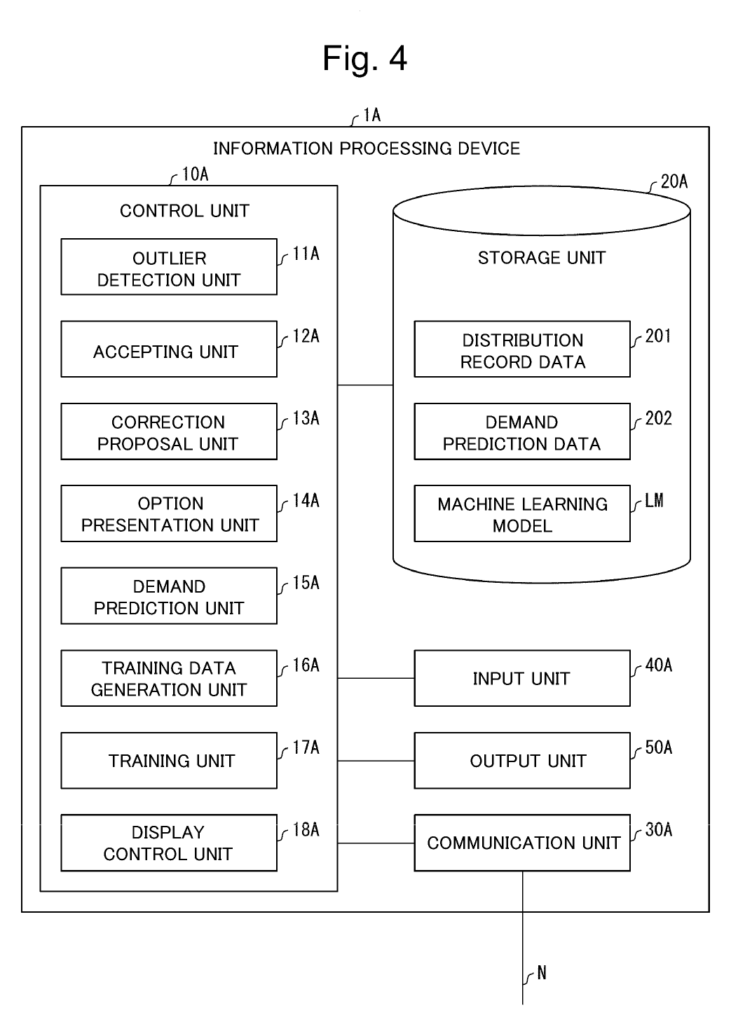

A configuration of the information processing device 1A will be described with reference to FIG. 4. FIG. 4 is a block diagram illustrating a configuration of the information processing device 1A. The information processing device 1A includes a control unit 10A, a storage unit 20A, a communication unit 30A, an input unit 40A, and an output unit 50A. The communication unit 30A communicates with a device (user terminal 2A, etc.) outside the information processing device 1A via the communication line N. The communication unit 30A transmits data supplied from the control unit 10A to another device, and supplies data received from another device to the control unit 10A.

### Input Unit/Output Unit

The input unit 40A is a configuration for accepting an input to the information processing device 1A, and includes, as an example, an input device such as a keyboard, a mouse, a touch panel, a camera, or a microphone. The input unit 40A may be configured to accept data from the input device via, for example, an interface such as a Universal Serial Bus (USB). The output unit 50A is a configuration for performing output from the information processing device 1A, and includes, as an example, an output device such as a display, a printer, a touch panel, or a speaker. The output unit 50A may include, for example, an interface such as a USB, and may be configured to output data to the output device via the interface.

### Storage Unit

The storage unit 20A stores various types of information to be referred to by the control unit 10A. Examples of such information include distribution record data 201, demand prediction data 202, and a machine learning model LM. Here, storing the machine learning model LM in the storage unit 20A means that parameters defining the machine learning model LM are stored in the storage unit 20A.

### Distribution Record Data/Demand Prediction Data

The distribution record data 201 is time-series data of the actual value for each unit period of the distribution volume of the product. Here, examples of the unit period include, for example, one month, one week, and one day. Examples of the actual value include, for example, the number of products sold (piece, box, etc.) and the sales amount. The distribution record data 201 includes, for example, Point of sale system (POS) data, EC shipment data, wholesale shipment data, manufacturer shipment data, and the like. The POS data is data obtained by aggregating sales record of a product at a retailer in units of a single product. As an example, the POS data includes information of a product name, a price, the number of products, a purchase store, a purchase date and time, and customer information (age group, sex, visit date and time, etc.). The EC shipment data is data indicating sales record of a product by electronic commerce. The wholesale shipment data is data indicating shipment record of the product by the wholesaler. The manufacturer shipment data is data indicating the shipment record of the product by the manufacturer. The demand prediction data 202 is data indicating a prediction result of the demand for the product. As an example, the demand prediction data 202 is time-series data of prediction values for each unit period of the demand for the product.

### Machine Learning Model

The machine learning model LM is a machine learning model trained by a training unit 17A to be described later using training data. Examples of the machine learning model LM include, but are not limited to, a neural network model such as a convolutional neural network or a recurrent neural network. The machine learning model LM is a model that learns factors of past outliers and predicts a degree of demand fluctuation in the future. As an example, the input of the machine learning model LM includes an actual value of the distribution volume of the product and information indicating a fluctuation factor. Furthermore, the input of the machine learning model LM may include information regarding sales of a product (main sales channel, number of distribution stores, and size of shipment and sales), information indicating a category of a product, information regarding marketing of a product, information indicating an external environment, and the like. As an example, the output of the machine learning model LM includes data indicating a fluctuation rate (how much % demand will fall, etc.) of the demand prediction due to the fluctuation factor.

### Control Unit

The control unit 10A includes an outlier detection unit 11A, an accepting unit 12A, a correction proposal unit 13A, an option presentation unit 14A, a demand prediction unit 15A, a training data generation unit 16A, a training unit 17A, and a display control unit 18A. Each of the outlier detection unit 11A, the accepting unit 12A, the correction proposal unit 13A, the option presentation unit 14A, the training data generation unit 16A, and the training unit 17A is an example of an outlier detection means, an accepting means, a correction proposal means, an option presentation means, a training data generation means, and a training means according to the present disclosure. The demand prediction unit 15A is an example of a prediction means, a second prediction means, and a third prediction means according to the present disclosure.

### Outlier Detection Unit

The outlier detection unit 11A detects an outlier from the distribution record data 201. The outlier is, for example, a value indicating motion different from normal motion. As an example, the outlier detection unit 11A detects an outlier by comparing the deviation of the actual value from the average with the standard deviation. More specifically, as an example, when the standard deviation of the distribution record data 201 in a predetermined period is set as σ and the average as μ, the outlier detection unit 11A detects, as an outlier, an actual value x_{N-i} in which a value of |x_{N-i} - μ|/σ is equal to or more than a threshold value defined in advance. However, the method by which the outlier detection unit 11A detects an outlier is not limited to the above-described example, and the outlier detection unit 11A may detect an outlier by another method.

### Accepting Unit

The accepting unit 12A accepts various instructions or selections by the user. As an example, the accepting unit 12A accepts the instruction or the selection by receiving data indicating the instruction or the selection of the user from the user terminal 2A. Furthermore, the accepting unit 12A may accept an instruction or selection input by the user to the input unit 40A.

The accepting unit 12A accepts, in particular, designation of a starting point of a period (first period) corresponding to the outlier detected by the outlier detection unit 11A by the user. Furthermore, in a case where the user selects a third option to be described later from among a plurality of options presented by the option presentation unit 14A to be described later, the accepting unit 12A accepts designation of an ending point of the period corresponding to the outlier detected by the outlier detection unit 11A by the user. Furthermore, in a case where the user selects the third option, the accepting unit 12A accepts designation of a fluctuation factor by the user. Here, the fluctuation factor is a factor by which the actual value has fluctuated (an outlier has occurred). Examples of the fluctuation factor include, but are not limited to, out of stock, sales of quantity-limited products (campaign products, etc.), measures, new adoption, dead stock, and the like.

### Correction Proposal Unit

The correction proposal unit 13A calculates the correction value of the actual value in the period (first period) corresponding to the outlier based on the actual value in a period (second period) before the starting point accepted by the accepting unit 12A. As an example, the correction proposal unit 13A predicts the actual value after the starting point by performing time-series analysis using the actual value in the period before the starting point accepted by the accepting unit 12A, and sets the predicted actual value as the correction value. However, the method by which the correction proposal unit 13A calculates the correction value is not limited to the above-described example, and the correction proposal unit 13A may calculate the correction value by another method.

Furthermore, the correction proposal unit 13A proposes the calculated correction value to the user. As an example, the correction proposal unit 13A outputs the calculated correction value to an output device (display, printer, speaker, etc.) and proposes the correction value to the user. The output device is, for example, an output device of the user terminal 2A. In this case, the correction proposal unit 13A transmits the correction value to the user terminal 2A via the communication unit 30A, and causes the output device of the user terminal 2A to output the correction value. Furthermore, the correction proposal unit 13A may output the correction value to an output device (display, speaker, printer, etc.) connected to the output unit 50A to propose the correction value to the user.

### Option Presentation Unit

The option presentation unit 14A presents a plurality of options regarding the correction to the user. As an example, the plurality of options include three options of “wait-and-see”, “temporary correction”, and “correction confirmation”. “Wait-and-see” is an option (first option) of not correcting the actual value in the period corresponding to the outlier. When this option is selected, the actual value is not corrected, and the correction value is not reflected on the actual value. Furthermore, in this case, the demand prediction unit 15A calculates the future demand prediction using the records up to the previous time point excluding the period of the outlier.

“Temporary correction” is an option (second option) of temporarily correcting the actual value in the period corresponding to the outlier with the correction value. Here, the temporary correction refers to holding both the actual value and the correction value without correcting the actual value with the correction value. When this option is selected, the actual value is not corrected, but the correction value is held in a storage device or the like. In this case, the demand prediction unit 15A performs demand prediction in the prediction target period using the correction value instead of the actual value.

“Correction confirmation” is an option (third option) of confirming the correction of the actual value in the period corresponding to the outlier. Here, confirming the correction means updating the actual value with the correction value. When this option is selected, the actual value is updated by the correction value. However, the actual value before correction is also held in the storage unit 20A and the like separately from the correction value. In this case, the demand prediction unit 15A performs demand prediction in the prediction target period using the updated actual value (i.e., correction value).

In a case where the influence of fluctuation factors such as out of stock and measures is continuing, the user selects “temporary correction” without confirming the correction. On the other hand, in a case where the influence of fluctuation factors such as out of stock and measures has ended, the user can confirm the correction and utilize the confirmed correction value for the subsequent demand prediction.

### Demand Prediction Unit

The demand prediction unit 15A predicts a demand for a product using the distribution record data 201. Examples of the method of demand prediction by the demand prediction unit 15A include, but are not limited to, (a) a method by time-series analysis and (b) a method using a trained model. (a) The method by time-series analysis is a method of analyzing data that changes with elapse of time and predicting how data in the next period changes, and a conventional analysis method can be used.

(b) The method using the trained model is a method of performing demand prediction by inputting various data to a trained model generated by machine learning. In this case, examples of the trained model include, but are not limited to, a neural network model such as a convolutional neural network or a recurrent neural network. In this case, the input of the trained model includes distribution record data as an example. Furthermore, the input of the trained model may include, in addition to the distribution record data, other data such as information indicating a category of a product, information regarding marketing of a product, and information indicating an external environment of each unit period. The information indicating the category of the product is, for example, information indicating the category of the product such as “drinking water” and “fresh food”. Examples of the information regarding the marketing of the product are, for example, information indicating the scale of the promotion and the period of the promotion. Examples of the information indicating the external environment are, for example, an average temperature and the number of foreign visitors. Furthermore, as an example, the output of the trained model includes the prediction result of the demand for the product for each unit period in the prediction target period. The trained model is stored in the storage device such as the storage unit 20A. Here, storing the trained model in the storage device means that the parameters defining the trained model are stored in the storage device.

In addition, the demand prediction unit 15A performs demand prediction according to an option selected by the user. More specifically, for example, in a case where “wait-and-see” (first option) is selected by the user, the demand prediction unit 15A predicts the demand for the product using the actual value before the first period without correcting the actual value in the first period. On the other hand, in a case where “temporary correction” (second option) is selected by the user, the demand prediction unit 15A corrects the actual value in the first period with the correction value, and predicts the demand for the product using the corrected actual value.

In a case where “correction confirmation” (third option) is selected by the user, the demand prediction unit 15A calculates a correction value of the actual value in the first period from the starting point to the ending point accepted by the accepting unit 12A, corrects the actual value in the period using the calculated correction value, and predicts the demand for the product using the corrected actual value.

### Training Data Generation Unit

The training data generation unit 16A generates training data used for training the machine learning model LM. As an example, the training data is data in which first data including the actual value of the distribution volume of the product and the fluctuation factor designated by the user and second data including the actual value corrected by the demand prediction unit 15A are associated with each other.

### Training Unit

The training unit 17A trains the machine learning model LM using the training data generated by the training data generation unit 16A. As an example, the training unit 17A sets the actual value of the distribution volume of the product and the fluctuation factor designated by the user as input data and sets the correction value of the actual value as output data, and trains the machine learning model LM by associating them with each other.

### Display Control Unit

The display control unit 18A outputs data representing various screens to a display (display device), and causes the display to display the screens. The display is, as an example, a display of the user terminal 2A. In this case, the display control unit 18A transmits data representing the screen to the user terminal 2A via the communication unit 30A, and displays the screen on the display of the user terminal 2A. In the present disclosure, when the display control unit 18A transmits the data representing the screen to the user terminal 2A and causes the display of the user terminal 2A to display the screen, this is also referred to as “the display control unit 18A displays a screen”. Furthermore, the display control unit 18A may cause the display connected to the output unit 50A to display the screen by outputting the data representing the screen to the display.

### Flow of Information Processing Method

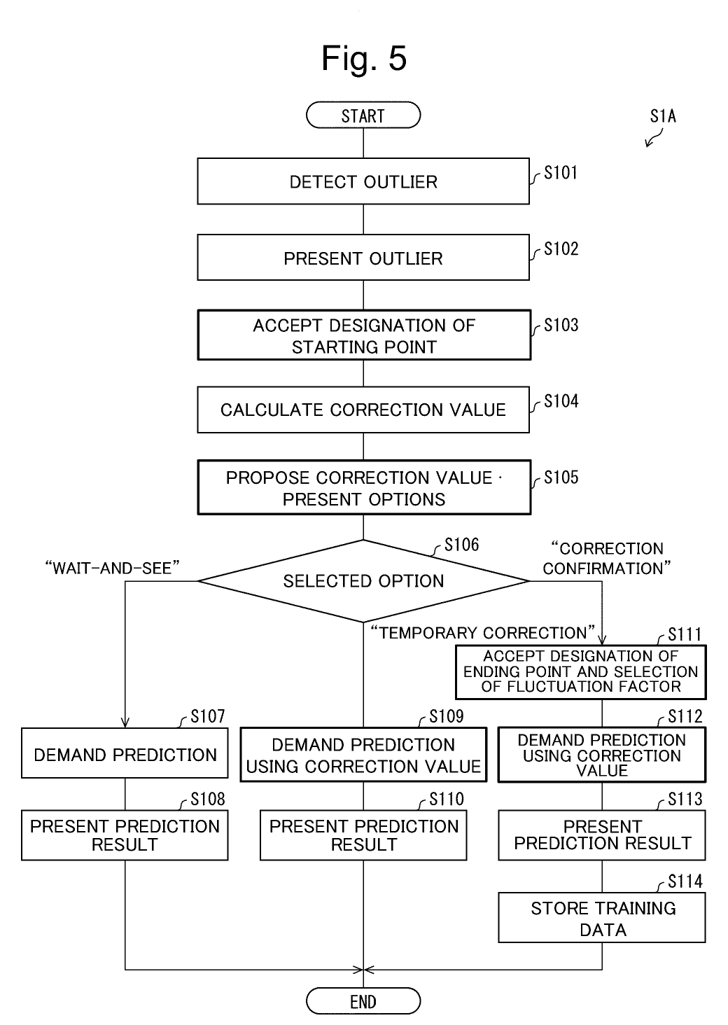

FIG. 5 is a flowchart illustrating an example of a flow of an information processing method performed by the demand prediction system 100A.

### Step S101

In step S101, the outlier detection unit 11A detects an outlier from the distribution record data 201. As an example, the outlier detection unit 11A detects an outlier by comparing the deviation of the actual value from the average with the standard deviation. More specifically, as an example, in a case where there is a record of the previous year, the standard deviation in a predetermined period of the record in the previous year is set as σ and the average is set as μ, and the outlier detection unit 11A detects, as an outlier, an actual value x_{N-i} in which a value of |x_{N-i} - μ|/σ is equal to or more than a threshold value defined in advance. On the other hand, in a case where there is no record of the previous year, as an example, the outlier detection unit 11A sets the standard deviation in the latest predetermined period as σ and the average as μ, and detects, as an outlier, an actual value x_{N-i} in which the value of |x_{N-i} - μ|/σ is equal to or more than a threshold value defined in advance.

### Step S102

In step S102, the display control unit 18A presents the outlier detected by the outlier detection unit 11A to the user. As an example, the display control unit 18A presents the detected outlier to the user by causing the display to display a screen indicating the outlier.

### First Display Example

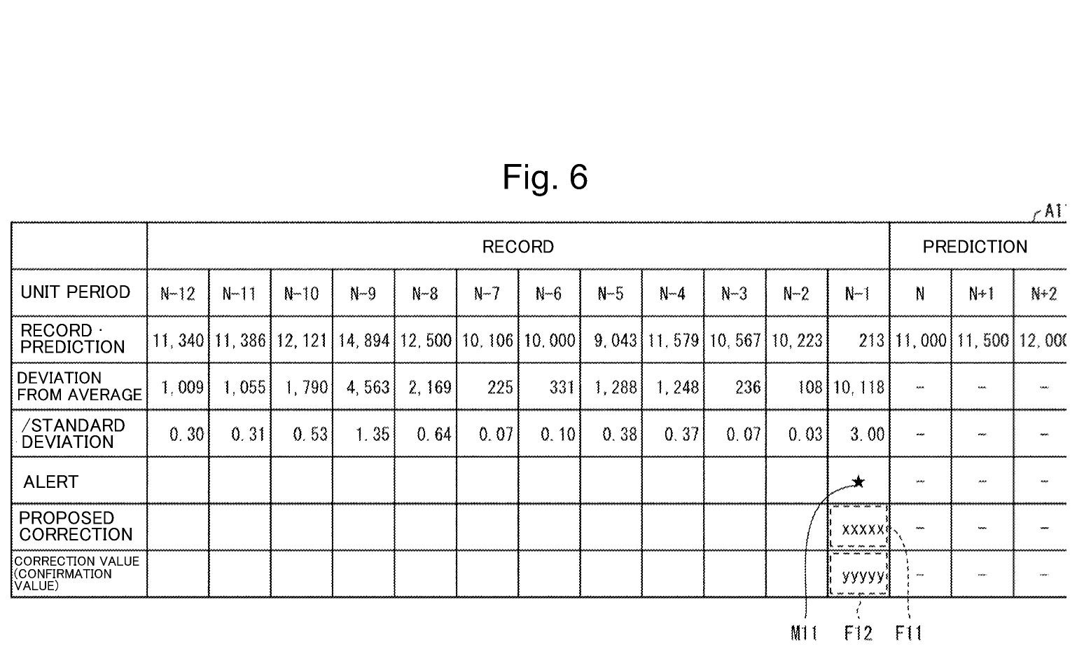

FIG. 6 is a diagram illustrating an example of a screen displayed on the display by the display control unit 18A. In the example of FIG. 6, in the display area A11 of the display, there are displayed the distribution record data indicating the record of the distribution volume in each of the unit periods N-12, N-11, ..., and the demand prediction data indicating the prediction result of the demand in each of the unit periods N, N+1, N+2, ....

In the example of FIG. 6, the distribution record data includes a plurality of items of “deviation from the average”, “/standard deviation”, “alert”, “proposed correction”, and “correction value (confirmed value)”. “Deviation from the average” is a value indicating the extent to which the actual value is away from the average. In the example of FIG. 6, when the standard deviation of the distribution record data in a predetermined period is set as σ and the average as μ, the deviation of the actual value x_{N-i} from the average μ is calculated by |x_{N-i} - μ|. “/Standard deviation” is a value |x_{N-i} - μ|/σ obtained by dividing the deviation |x_{N-i} - μ| from the average by the standard deviation σ. The value is also referred to as an alert index P_{N-i}.

In “alert”, information indicating whether the actual value is an outlier is displayed. In the example of FIG. 6, in a case where the actual value is an outlier, a mark M11 indicating the fact is displayed in this item, and in a case where the actual value is not an outlier, nothing is displayed in this item.

By way of example, the alert index P_{N-i} is used for the determination on whether the actual value is an outlier. As an example, in a case where the alert index P_{N-i} is equal to or more than a threshold value defined in advance, the outlier detection unit 11A determines that the actual value is an outlier.

In addition, in the display area A11 of FIG. 6, the user can designate the starting point of the period corresponding to the outlier. More specifically, in a case where the actual value of the unit period N-1 is detected as an outlier, the user designates either the unit period N-1 or the unit period before the unit period N-1 as a starting point by using the input device or the like of the user terminal 2A.

### Second Screen Example

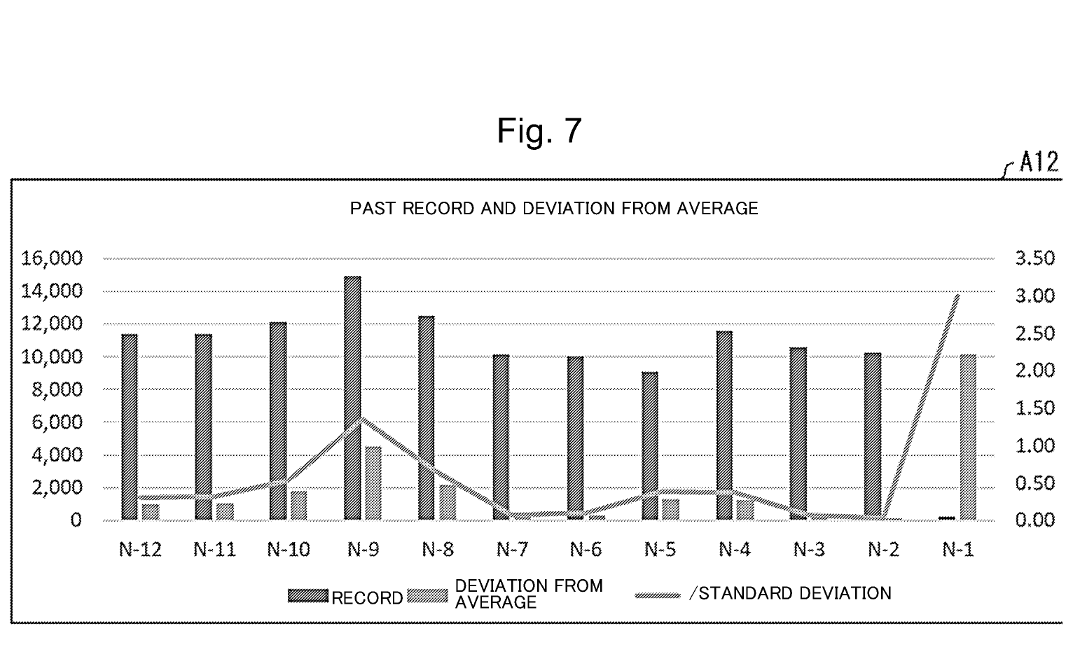

The display control unit 18A may display a graph illustrated in FIG. 7 in addition to the table TBL11 illustrated in FIG. 6. FIG. 7 is a diagram illustrating an example of a graph displayed on the display by the display control unit 18A. In the example of FIG. 7, a graph of the actual value of the distribution volume, the value indicating the deviation from the average, and the value obtained by dividing the deviation from the average by the standard deviation is displayed in the display area A12.

### Steps S103 · S104

In step S103, the accepting unit 12A accepts designation of a starting point by the user. In step S104, the correction proposal unit 13A calculates the correction value of the actual value in the period (first period) corresponding to the outlier based on the actual value in the period (second period) before the starting point accepted in step S103.

### Step S105

In step S105, the correction proposal unit 13A proposes the calculated correction value to the user by displaying on a display or the like. Specifically, as an example, the correction proposal unit 13A displays the calculated proposed correction in the field F11 of “proposed correction” in the unit period N-1 of the display area A11 in FIG. 6.

Furthermore, in step S105, the option presentation unit 14A presents a plurality of options (“wait-and-see”, “temporary correction”, “correction confirmation”, and the like) to the user. As an example, the option presentation unit 14A displays a Graphical User Interface (GUI) for selecting any of a plurality of options in the display area A11. The user performs an operation of selecting any of the plurality of presented options by using the input device of the user terminal 2A. When any of the plurality of options is selected by the user, the user terminal 2A transmits data indicating the selected option to the information processing device 1A.

### Step S106

In step S106, the option presentation unit 14A determines which option has been selected by the user. In a case where “wait-and-see” is selected (step S106: “wait-and-see”), the option presentation unit 14A proceeds to step S107. In a case where “temporary correction” is selected (step S106: “temporary correction”), the option presentation unit 14A proceeds to processing of step S109. In a case where “correction confirmation” is selected (step S106: “correction confirmation”), the option presentation unit 14A proceeds to processing of step S111.

### Steps S107 · S108

In step S107, the demand prediction unit 15A performs demand prediction of the product using the actual value that is not corrected. In step S108, the display control unit 18A presents the demand prediction result in step S107 to the user by displaying it on the display or the like.

### Steps S109 · S110

In step S109, the demand prediction unit 15A performs demand prediction of a product using the correction value calculated in step S104. In step S110, the display control unit 18A presents the demand prediction result in step S109 to the user by displaying it on the display or the like.

### Step S111

In step S111, the accepting unit 12A accepts designation of the ending point of the period corresponding to the outlier and selection of the fluctuation factor. As an example, in the display area A11 of FIG. 6, the accepting unit 12A displays information for the user to designate the ending point of the period corresponding to the outlier on the display, and accepts the designation of the ending point. In addition, the accepting unit 12A displays, on the display, information for selecting a factor of an outlier in the display area A11, and accepts selection of a fluctuation factor. The user designates an ending point using an input device or the like of the user terminal 2A and selects a fluctuation factor. When the ending point is designated and the fluctuation factor is selected by the user, the user terminal 2A transmits data indicating the ending point and data indicating the fluctuation factor to the information processing device 1A.

### Steps S112 · S113

In step S112, the demand prediction unit 15A updates the actual value with the correction value, and performs demand prediction of the product using the correction value. In step S113, the display control unit 18A presents the demand prediction result in step S112 to the user by displaying it on the display or the like.

### Step S114

In step S114, the training data generation unit 16A stores the training data including the data indicating the fluctuation factor accepted in step S111, the distribution record data, and the data indicating the period from the starting point to the ending point designated by the user in the storage unit 20A. In addition to the above data, the training data may include information indicating an attribute (channel etc.) of a product, information indicating a category of a product, information regarding marketing of a product, information indicating an external environment, and the like.

The training data stored in the storage unit 20A is used for machine learning of the machine learning model LM by the training unit 17A. By way of an example, the machine learning model LM trained by the training unit 17A is used for demand prediction. For example, the demand prediction unit 15A may perform the demand prediction of the product based on the output data obtained by inputting the input data including the actual value of the distribution volume of the product and the information indicating the fluctuation factor to the machine learning model LM.

### Response to Level Change

As described above, when “correction confirmation” is selected by the user, the demand prediction unit 15A corrects the actual value of the period determined by the starting point and the ending point designated by the user, and predicts the demand for the product using the corrected actual value. As a result, it is possible to perform demand prediction in consideration of the influence of temporary demand fluctuation. On the other hand, demand fluctuation may not be temporary but may continue. For example, in a case where the fluctuation factor is “out of stock”, “limited product”, or “measures”, the period of influence of the fluctuation factor is temporary, whereas in a case where the fluctuation factor is“ newly adopted” or “dead stock”, the period of influence of the fluctuation factor is assumed to continue. As described above, a change point or a change rate may be designated by the user for a non-temporary demand fluctuation. In this case, the user may input the change rate in the level of demand for the non-temporary demand fluctuation, and the demand prediction unit 15A may adjust only the level while maintaining the trend and the seasonal characteristics in the demand prediction. In other words, it can also be said that the demand prediction unit 15A predicts the demand for the product by changing the level of the actual value according to the fluctuation factor accepted by the accepting unit 12A when the fluctuation factor accepted by the accepting unit 12A is caused by continuous demand fluctuation.

In this case, as an example, when the fluctuation factor accepted by the accepting unit 12A is a fluctuation factor (“out of stock”, “limited product”, “measures”, etc.) caused by a temporary demand fluctuation, the training data generation unit 16A generates training data in which the first data and the second data are associated with each other. On the other hand, the training data generation unit 16A does not generate the training data when the fluctuation factor accepted by the accepting unit 12A is a fluctuation factor (“newly adopted”, “dead stock”, etc.) caused by a temporary demand fluctuation.

### Effects of Information Processing Device

As described above, the information processing device 1A not only detects an outlier from the actual value of the distribution volume, but also proposes a correction value of the detected outlier to the user. As a result, the user of the information processing device 1A can decide how to correct (or not to correct) the actual value used for demand prediction with reference to the proposed correction value. That is, according to the information processing device 1A, the user can easily decide how to correct (or not to correct) the actual value with reference to the proposed correction value.

Furthermore, instead of uniformly reflecting the proposed correction, the information processing device 1A presents, to the user, a first option of not correcting the actual value, a second option of temporarily correcting the actual value with the correction value, and a third option of confirming the correction of the actual value. As a result, the user of the information processing device 1A can check the proposed correction that has been proposed and select whether not to perform the correction, whether to perform the temporary correction, or whether to confirm the correction, and can reflect the user's intention in the demand prediction by a simple operation.

Furthermore, the information processing device 1A adopts a configuration of including the demand prediction unit 15A for predicting, in a case where the first option is selected by the user, the demand for the product using the actual value before the first period without correcting the actual value in the first period. Therefore, according to the information processing device 1A, demand prediction reflecting user's intention can be performed.

Furthermore, the information processing device 1A adopts a configuration of including the demand prediction unit 15A for correcting, in a case where the second option is selected by the user, the actual value in the first period with the correction value and predicting the demand for the product using the corrected actual value. Therefore, according to the information processing device 1A, demand prediction reflecting user's intention can be performed.

Furthermore, in the information processing device 1A, in a case where the third option is selected by the user, the accepting unit 12A accepts the designation of the ending point of the period corresponding to the outlier detected by the outlier detection unit 11A by the user, and the information processing device 1A adopts a configuration of including the demand prediction unit 15A is provided to calculate the correction value of the actual value in the first period from the starting point to the ending point accepted by the accepting unit 12A, correct the actual value in the first period using the calculated correction value, and predict the demand for the product using the corrected actual value. Therefore, according to the information processing device 1A, demand prediction reflecting user's intention can be performed.

Furthermore, in the information processing device 1A, in a case where the third option is selected by the user, the accepting unit 12A accepts designation of a fluctuation factor by the user, and the information processing device 1A adopts a configuration of including a training data generation unit 16A for generating training data in which first data including the actual value of the distribution volume of the product and the fluctuation factor designated by the user and second data including the actual value corrected by the demand prediction unit 15A are associated with each other. Therefore, according to the information processing device 1A, in a case where a fluctuation factor similar to that in the past is assumed in the future, it is possible to generate training data used for training of a machine learning model capable of reflecting the influence of the fluctuation factor in demand prediction.

Furthermore, the information processing device 1A adopts a configuration of including a training unit 17A for training a machine learning model by using the training data generated by the training data generation unit 16A using an actual value of a distribution volume of a product and a fluctuation factor designated by the user as input data and a correction value of the actual value as output data and associating the data. Therefore, according to the information processing device 1A, in a case where a fluctuation factor similar to that in the past is assumed in the future, it is possible to generate a machine learning model capable of reflecting the influence of the fluctuation factor in the demand prediction. With this machine learning model, for example, the user can reflect the influence of a fluctuation factor in the demand prediction in a case where a fluctuation factor similar to that in the past is assumed in the future by merely designating the fluctuation factor.

Furthermore, in the information processing device 1A, a configuration is adopted in which the training data generation unit 16A generates the training data in which the first data and the second data are associated with each other in a case where the fluctuation factor accepted by the accepting unit 12A is caused by a temporary demand fluctuation, and does not generate the training data in a case where the fluctuation factor accepted by the accepting unit 12A is caused by a temporary demand fluctuation. As described above, it is possible to generate the machine learning model LM with higher prediction accuracy by generating the training data for machine learning only for the fluctuation factor caused by the temporary demand fluctuation.

Furthermore, the information processing device 1A adopts a configuration in which, in a case where the fluctuation factor accepted by the accepting unit 12A is caused by continuous demand fluctuation, the demand prediction unit 15A changes the level of the actual value according to the fluctuation factor accepted by the accepting unit 12A to predict the demand for the product.

### Implementation Example by Software

Some or all of the functions of the outlier correction device 1, the information processing device 1A (hereinafter, also referred to as “each of the above devices”) may be implemented by hardware such as an integrated circuit (IC chip) or may be implemented by software.

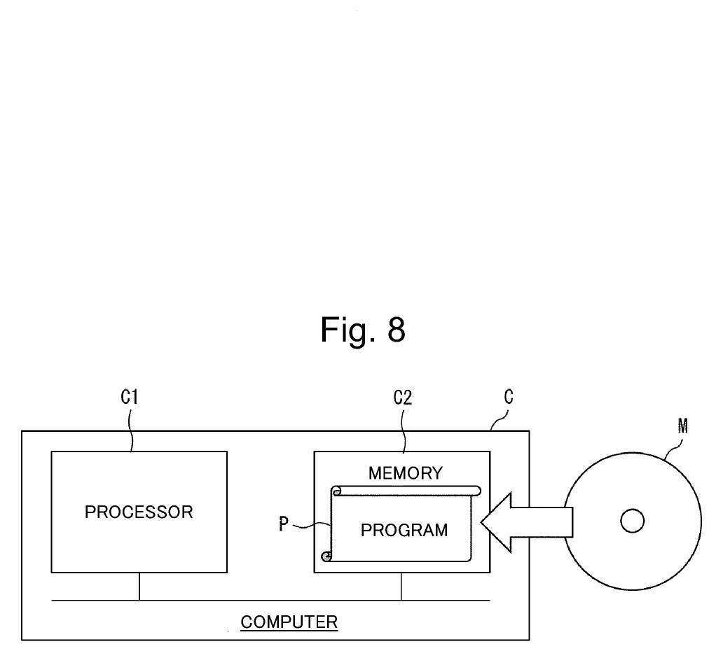

In the latter case, each of the above devices is achieved by, for example, a computer that executes a command of a program as software for achieving each function. An example of such a computer (hereinafter, referred to as a computer C) is illustrated in FIG. 8. FIG. 8 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination of these can be used. As the memory C2, for example, a flash memory, a Hard Disk Drive (HDD), a Solid State Drive (SSD), or a combination of these can be used.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

According to an exemplary aspect of the present disclosure, an exemplary effect that a technology for more accurately performing demand prediction of a product is obtained.

### Supplementary Matter A

The present disclosure includes technologies described in the following Supplementary Notes. However, the present disclosure is not limited to the technologies described in the following Supplementary Notes, and various modifications can be made within the scope described in the claims.

### Supplementary Note A1

An outlier correction device including:

an outlier detection means for detecting an outlier from an actual value of a distribution volume of a product for each unit period,

an accepting means for accepting designation of a starting point of a first period corresponding to the outlier detected by the outlier detection means by a user,

a correction proposal means for calculating a correction value of an actual value in the first period based on an actual value in a second period before the starting point accepted by the accepting means and proposing the calculated correction value to the user, and

an option presentation means for presenting, to the user, a first option of not correcting the actual value in the first period, a second option of temporarily correcting the actual value in the first period with the correction value, and a third option of confirming correction of the actual value in the first period.

### Supplementary Note A2

The outlier correction device according to Supplementary Note A1, further including a prediction means for predicting a demand of the product using an actual value before the first period without correcting the actual value in the first period in a case where the first option is selected by the user.

### Supplementary Note A3

The outlier correction device according to Supplementary Note A1 or A2, further including a second prediction means for correcting the actual value in the first period with the correction value and predicting a demand of the product using the corrected actual value in a case where the second option is selected by the user.

### Supplementary Note A4

The outlier correction device according to any one of Supplementary Notes A1 to A3, in which

in a case where the third option is selected by the user, the accepting means accepts designation of an ending point of a period corresponding to the outlier detected by the outlier detection means by the user, and

the outlier correction device further includes

a third prediction means for calculating a correction value of the actual value in the first period from the starting point to the ending point accepted by the accepting means, correcting the actual value in the first period using the calculated correction value, and predicting a demand of a product using the corrected actual value.

### Supplementary Note A5

The outlier correction device according to Supplementary Note A4, in which

the accepting means accepts designation of a fluctuation factor by the user in a case where the third option is selected by the user, and

the outlier correction device further includes

a training data generation means for generating training data in which first data including an actual value of a distribution volume of the product and the fluctuation factor designated by the user and second data including an actual value corrected by the third prediction means are associated with each other.

### Supplementary Note A6

The outlier correction device according to Supplementary Note A5, further including a training means for training a machine learning model by using the training data generated by the training data generation means, using an actual value of the distribution volume of the product and the fluctuation factor designated by the user as input data, and a correction value of the actual value as output data, and associating the data with each other.

### Supplementary Note A7

The outlier correction device according to Supplementary Note A5 or A6, in which the training data generation means generates training data in which the first data and the second data are associated with each other in a case where the fluctuation factor accepted by the accepting means is caused by a temporary demand fluctuation, and does not generate the training data in a case where the fluctuation factor accepted by the accepting means is caused by a temporary demand fluctuation.

### Supplementary Note A8

The outlier correction device according to any one of Supplementary Notes A5 to A7, in which in a case where the fluctuation factor accepted by the accepting means is caused by continuous demand fluctuation, the third prediction means predicts the demand of the product by changing a level of the actual value according to the fluctuation factor accepted by the accepting means.

### Supplementary Matter B

The present disclosure includes technologies described in the following Supplementary Notes. However, the present disclosure is not limited to the technologies described in the following Supplementary Notes, and various modifications can be made within the scope described in the claims.

### Supplementary Note B1

An outlier correction method including:

outlier detection processing in which at least one processor detects an outlier from an actual value of a distribution volume of a product for each unit period,

acceptance processing in which the at least one processor accepts designation of a starting point of a first period corresponding to the outlier detected in the outlier detection processing by a user,

correction proposal processing in which the at least one processor calculates a correction value of an actual value in the first period based on an actual value in a second period before the starting point accepted in the acceptance processing and proposes the calculated correction value to the user, and

option presentation processing in which the at least one processor presents, to the user, a first option of not correcting the actual value in the first period, a second option of temporarily correcting the actual value in the first period with the correction value, and a third option of confirming correction of the actual value in the first period.

### Supplementary Note B2

The outlier correction method according to Supplementary Note B1, further including prediction processing in which the at least one processor predicts a demand of the product using an actual value before the first period without correcting the actual value in the first period in a case where the first option is selected by the user.

### (Supplementary Note B3)

The outlier correction method according to Supplementary Note B1 or B2, further including second prediction processing in which the at least one processor corrects the actual value in the first period with the correction value and predicts a demand of the product using the corrected actual value in a case where the second option is selected by the user.

### Supplementary Note B4

The outlier correction method according to any one of Supplementary Notes B1 to B3, in which

in a case where the third option is selected by the user, the at least one processor accepts designation of an ending point of a period corresponding to the outlier detected in the outlier detection processing by the user in the acceptance processing, and

the outlier correction method further includes

third prediction processing in which the at least one processor calculates a correction value of an actual value in the first period from the starting point to the ending point accepted in the acceptance processing, corrects the actual value in the first period using the calculated correction value, and predicts a demand of a product using the corrected actual value.

### Supplementary Note B5

The outlier correction method according to Supplementary Note B4, in which

in the acceptance processing, the at least one processor accepts designation of a fluctuation factor by the user in a case where the third option is selected by the user, and

the outlier correction method further includes

training data generation processing in which the at least one processor generates training data in which first data including an actual value of a distribution volume of the product and the fluctuation factor designated by the user and second data including the actual value corrected by the third prediction processing are associated with each other.

### Supplementary Note B6

The outlier correction method according to Supplementary Note B5, further including training processing in which the at least one processor trains a machine learning model by using training data generated in the training data generation processing, using an actual value of a distribution volume of the product and the fluctuation factor designated by the user as input data, and a correction value of the actual value as output data, and associating the data with each other.

### Supplementary Note B7

The outlier correction method according to Supplementary Note B5 or B6, in which in the training data generation processing, the at least one processor generates training data in which the first data and the second data are associated with each other in a case where the fluctuation factor accepted in the acceptance processing is caused by a temporary demand fluctuation, and does not generate the training data in a case where the fluctuation factor accepted in the acceptance processing is caused by a temporary demand fluctuation.

### Supplementary Note B8

The outlier correction method according to any one of Supplementary Notes B5 to B7, in which in a case where the fluctuation factor accepted in the acceptance processing is caused by continuous demand fluctuation, the at least one processor predicts the demand of the product by changing a level of the actual value according to the fluctuation factor accepted in the acceptance processing in the third prediction processing.

### Supplementary Matter C

The present disclosure includes technologies described in the following Supplementary Notes. However, the present disclosure is not limited to the technologies described in the following Supplementary Notes, and various modifications can be made within the scope described in the claims.

### Supplementary Note C1

An outlier correction program for causing a computer to function as an outlier correction device, the outlier correction program causing the computer to function as:

an outlier detection means for detecting an outlier from an actual value of a distribution volume of a product for each unit period,

an accepting means for accepting designation of a starting point of a first period corresponding to the outlier detected by the outlier detection means by a user,

a correction proposal means for calculating a correction value of an actual value in the first period based on an actual value in a second period before the starting point accepted by the accepting means and proposing the calculated correction value to the user, and

an option presentation means for presenting, to the user, a first option of not correcting the actual value in the first period, a second option of temporarily correcting the actual value in the first period with the correction value, and a third option of confirming correction of the actual value in the first period.

### Supplementary Note C2

The outlier correction program according to Supplementary Note C1, further causing the computer to function as a prediction means for predicting a demand of the product using an actual value before the first period without correcting the actual value in the first period in a case where the first option is selected by the user.

### Supplementary Note C3

The outlier correction program according to Supplementary Note C1 or C2, further causing the computer to function as a second prediction means for correcting the actual value in the first period with the correction value and predicting a demand of the product using the corrected actual value in a case where the second option is selected by the user.

### Supplementary Note C4

The outlier correction program according to any one of Supplementary Notes C1 to C3, in which

in a case where the third option is selected by the user, the accepting means accepts designation of an ending point of a period corresponding to the outlier detected by the outlier detection means by the user, and

the program further causes the computer to function as:

a third prediction means for calculating a correction value of the actual value in the first period from the starting point to the ending point accepted by the accepting means, correcting the actual value in the first period using the calculated correction value, and predicting a demand of a product using the corrected actual value.

### Supplementary Note C5

The outlier correction program according to Supplementary Note C4, in which

the accepting means accepts designation of a fluctuation factor by the user in a case where the third option is selected by the user, and

the program further causes the computer to function as:

a training data generation means for generating training data in which first data including an actual value of a distribution volume of the product and the fluctuation factor designated by the user and second data including an actual value corrected by the third prediction means are associated with each other.

### Supplementary Note C6

The outlier correction program according to Supplementary Note C5, further causing the computer to function as a training means for training a machine learning model by using the training data generated by the training data generation means, using an actual value of the distribution volume of the product and the fluctuation factor designated by the user as input data, and a correction value of the actual value as output data, and associating the data with each other.

### Supplementary Note C7

The outlier correction program according to Supplementary Note C5 or C6, in which the training data generation means generates training data in which the first data and the second data are associated with each other in a case where the fluctuation factor accepted by the accepting means is caused by a temporary demand fluctuation, and does not generate the training data in a case where the fluctuation factor accepted by the accepting means is caused by a temporary demand fluctuation.

### Supplementary Note C8

The outlier correction program according to any one of Supplementary Notes C5 to C7, in which in a case where the fluctuation factor accepted by the accepting means is caused by continuous demand fluctuation, the third prediction means predicts the demand of the product by changing a level of the actual value according to the fluctuation factor accepted by the accepting means.

### Supplementary Matter D

The present disclosure includes technologies described in the following Supplementary Notes. However, the present disclosure is not limited to the technologies described in the following Supplementary Notes, and various modifications can be made within the scope described in the claims.

### Supplementary Note D1

An outlier correction device including at least one processor, the at least one processor executing:

outlier detection processing of detecting an outlier from an actual value of a distribution volume of a product for each unit period,

acceptance processing of accepting designation of a starting point of a first period corresponding to the outlier detected in the outlier detection processing by a user,

correction proposal processing of calculating a correction value of an actual value in the first period based on an actual value in a second period before the starting point accepted in the acceptance processing and proposing the calculated correction value to the user, and

option presentation processing of presenting, to the user, a first option of not correcting the actual value in the first period, a second option of temporarily correcting the actual value in the first period with the correction value, and a third option of confirming correction of the actual value in the first period.

Note that the outlier correction device may further include a memory. The memory may store a program for causing the at least one processor to execute each of the processing.

### Supplementary Note D2

The outlier correction device according to Supplementary Note D1, in which the at least one processor further executes prediction processing of predicting a demand of the product using an actual value before the first period without correcting the actual value in the first period in a case where the first option is selected by the user.

### Supplementary Note D3

The outlier correction device according to Supplementary Note D1 or D2, in which the at least one processor further executes second prediction processing of correcting the actual value in the first period with the correction value and predicting a demand of the product using the corrected actual value in a case where the second option is selected by the user.

### Supplementary Note D4

The outlier correction device according to any one of Supplementary Notes D1 to D3, in which

in a case where the third option is selected by the user, the acceptance processing accepts designation of an ending point of a period corresponding to the outlier detected in the outlier detection processing by the user in the acceptance processing, and

the at least one processor further executes:

third prediction processing of calculating a correction value of an actual value in the first period from the starting point to the ending point accepted in the acceptance processing, correcting the actual value in the first period using the calculated correction value, and predicting a demand of a product using the corrected actual value.

### (Supplementary Note D5)

The outlier correction device according to Supplementary Note D4, in which

in the acceptance processing, the at least one processor accepts designation of a fluctuation factor by the user in a case where the third option is selected by the user, and

the at least one processor further executes:

training data generation processing of generating training data in which first data including an actual value of a distribution volume of the product and the fluctuation factor designated by the user and second data including the actual value corrected by the third prediction processing are associated with each other.

### Supplementary Note D6

The outlier correction device according to Supplementary Note D5, in which the at least one processor further executes training processing of training a machine learning model by using training data generated in the training data generation processing, using an actual value of a distribution volume of the product and the fluctuation factor designated by the user as input data, and a correction value of the actual value as output data, and associating the data with each other.

### Supplementary Note D7

The outlier correction device according to Supplementary Note D5 or D6, in which in the training data generation processing, the at least one processor generates training data in which the first data and the second data are associated with each other in a case where the fluctuation factor accepted in the acceptance processing is caused by a temporary demand fluctuation, and does not generate the training data in a case where the fluctuation factor accepted in the acceptance processing is caused by a temporary demand fluctuation.

### Supplementary Note D8

The outlier correction device according to any one of Supplementary Notes D5 to D7, in which in a case where the fluctuation factor accepted in the acceptance processing is caused by continuous demand fluctuation, the third prediction processing predicts the demand of the product by changing a level of the actual value according to the fluctuation factor accepted by the acceptance processing.

### Supplementary Matter E

The present disclosure includes technologies described in the following Supplementary Note. However, the present disclosure is not limited to the technologies described in the following Supplementary Note, and various modifications can be made within the scope described in the claims.

### Supplementary Note E1

A non-transitory recording medium recorded with an outlier correction program for causing a computer to function as an outlier correction device, the outlier correction program causing the computer to execute:

outlier detection processing of detecting an outlier from an actual value of a distribution volume of a product for each unit period,

acceptance processing of accepting designation of a starting point of a first period corresponding to the outlier detected in the outlier detection processing by a user,

correction proposal processing of calculating a correction value of an actual value in the first period based on an actual value in a second period before the starting point accepted in the acceptance processing and proposing the calculated correction value to the user, and

option presentation processing of presenting, to the user, a first option of not correcting the actual value in the first period, a second option of temporarily correcting the actual value in the first period with the correction value, and a third option of confirming correction of the actual value in the first period.

1. An outlier correction device comprising:
a memory configured to store instructions; and
one or more processors configured to execute the instructions to:
detect an outlier from an actual value of a distribution volume of a product for each unit period;
accept designation of a starting point of a first period corresponding to the outlier detected by a user;
calculating a correction value of an actual value in the first period based on an actual value in a second period before the starting point;
propose the calculated correction value to the user; and
present, to the user, a first option of not correcting the actual value in the first period, a second option of temporarily correcting the actual value in the first period with the correction value, and a third option of confirming correction of the actual value in the first period.

2. The outlier correction device according to claim 1, further comprising:
the one or more processors are further configured to execute the instructions to:
predict a demand of the product using an actual value before the first period without correcting the actual value in the first period in a case where the first option is selected by the user.

3. The outlier correction device according to claim 1, further comprising:
the one or more processors are further configured to execute the instructions to:
correct the actual value in the first period with the correction value: and
predict a demand of the product using the corrected actual value in a case where the second option is selected by the user.

4. The outlier correction device according to claim 1, wherein
the one or more processors are further configured to execute the instructions to:
in a case where the third option is selected by the user, accept designation of an ending point of a period corresponding to the outlier by the user, and
calculate a correction value of the actual value in the first period from the starting point to the ending point;
correct the actual value in the first period using the calculated correction value; and
predict a demand of a product using the corrected actual value.

5. The outlier correction device according to claim 4, wherein
the one or more processors are further configured to execute the instructions to:
accept designation of a fluctuation factor by the user in a case where the third option is selected by the user;
generate training data in which first data including an actual value of a distribution volume of the product and the fluctuation factor designated by the user and second data including the corrected actual value are associated with each other.

6. The outlier correction device according to claim 5, further comprising:
the one or more processors are further configured to execute the instructions to:
train a machine learning model by using the training data, using an actual value of the distribution volume of the product and the fluctuation factor designated by the user as input data, and a correction value of the actual value as output data, and associating the data with each other.

7. The outlier correction device according to claim 5, wherein
the one or more processors are further configured to execute the instructions to:
generate training data in which the first data and the second data are associated with each other in a case where the fluctuation factor is caused by a temporary demand fluctuation, and does not generate the training data in a case where the accepted fluctuation factor is caused by a non-temporary demand fluctuation.

8. The outlier correction device according to claim 5, wherein
the one or more processors are further configured to execute the instructions to:
in a case where the accepted fluctuation factor is caused by continuous demand fluctuation, predict the demand of the product by changing a level of the actual value according to the accepted fluctuation factor.

9. The outlier correction device according to claim 1, wherein
the one or more processors are further configured to execute the instructions to:
propose the correction value as information to aid the user's decision-making in selecting one of the first, second, or third options.

10. An outlier correction method comprising:
detecting an outlier from an actual value of a distribution volume of a product for each unit period;
accepting designation of a starting point of a first period corresponding to the outlier detected by a user;
calculating a correction value of an actual value in the first period based on an actual value in a second period before the starting point;
proposing the calculated correction value to the user; and
presenting, to the user, a first option of not correcting the actual value in the first period, a second option of temporarily correcting the actual value in the first period with the correction value, and a third option of confirming correction of the actual value in the first period.

11. A non-transitory computer-readable recording medium storing a outlier correction program for causing a computer to execute the steps of:
detecting an outlier from an actual value of a distribution volume of a product for each unit period;
accepting designation of a starting point of a first period corresponding to the outlier detected by a user;
calculating a correction value of an actual value in the first period based on an actual value in a second period before the starting point;
proposing the calculated correction value to the user; and
presenting, to the user, a first option of not correcting the actual value in the first period, a second option of temporarily correcting the actual value in the first period with the correction value, and a third option of confirming correction of the actual value in the first period.
